(19) United States
(12) Patent Application Publication
(10) Pub. No.: US 2012/0182225 A1
(43) Pub. Date: Jul. 19, 2012

(54) Detection of Predetermined Objects with Capacitive Touchscreens or Touch Panels

(75) Inventor: Michael Brosnan, Fremont, CA (US)

(73) Assignee: Avago Technologies ECBU IP (Singapore) Pte. Ltd., Fort Collins, CO (US)

(21) Appl. No.: 13/008,009

(22) Filed: Jan. 17, 2011

(51) Int. Cl. G06F 3/041

(52) U.S. Cl. 345/173

(57) ABSTRACT

Various embodiments of systems, devices, components and methods of detecting the presence of at least one predetermined object held against a capacitive touchscreen by a user's finger or hand are disclosed. The predetermined object is held or placed against a touchscreen or touch panel, and sensed mutual capacitance signals are routed to a processor. The processor determines whether the sensed signals correspond to the at least one predetermined object on the basis of one or more predetermined ranges of mutual capacitances corresponding to the predetermined object, where the predetermined range of mutual capacitances does not correspond to a user's finger or hand. Other characteristics of the predetermined object may also be determined, such as the object's shape, orientation or electrical resistance.

### FIELD OF THE INVENTION

Various embodiments of the invention described herein relate to the field of capacitive sensing input devices generally, and more specifically to devices and methods for detecting predetermined objects placed on a capacitive touchscreen or touch panel.

### BACKGROUND

Two principal capacitive sensing and measurement technologies are currently employed in most touchpad and touchscreen devices. The first such technology is that of self-capacitance. Many devices manufactured by SYNAPTICS™ employ self-capacitance measurement techniques, as do integrated circuit (IC) devices such as the CYPRESS PSOC.™ Self-capacitance involves measuring the self-capacitance of a series of electrode pads using techniques such as those described in U.S. Pat. No. 5,543,588 to Bisset et al. entitled “Touch Pad Driven Handheld Computing Device” dated Aug. 6, 1996.

Self-capacitance may be measured through the detection of the amount of charge accumulated on an object held at a given voltage (Q=CV). Self-capacitance is typically measured by applying a known voltage to an electrode, and then using a circuit to measure how much charge flows to that same electrode. When external objects are brought close to the electrode, additional charge is attracted to the electrode. As a result, the self-capacitance of the electrode increases. Many touch sensors are configured such that the grounded object is a finger grounded through the human body, where the body is essentially a capacitor to a surface where the electric field vanishes, and typically has a capacitance of around 100 pF.

Electrodes in self-capacitance touchpads are typically arranged in rows and columns. By scanning first rows and then columns the locations of individual mutual capacitance changes induced by the presence of a finger, for example, can be determined. To effect accurate multi-touch measurements in a touchpad, however, it may be required that several finger touches be measured simultaneously. In such a case, row and column techniques for self-capacitance measurement can lead to inconclusive results.

One way in which the number of electrodes can be reduced in a self-capacitance system is by interleaving the electrodes in a saw-tooth pattern. Such interleaving creates a larger region where a finger is sensed by a limited number of adjacent electrodes allowing better interpolation, and therefore fewer electrodes. Such patterns can be particularly effective in one dimensional sensors, such as those employed in IPOD click-wheels. See, for example, U.S. Pat. No. 6,879,930 to Sinclair et al. entitled Capacitance touch slider dated Apr. 12, 2005.

The second primary capacitive sensing and measurement technology employed in touchpad and touchscreen devices is that of mutual capacitance, where measurements are performed using a crossed grid of electrodes. See, for example, U.S. Pat. No. 5,861,875 to Gerpheide entitled “Methods and Apparatus for Data Input” dated Jan. 19, 1999. Mutual capacitance technology is employed in touchpad devices manufactured by CIRQUE™. In mutual capacitance measurement, capacitance is measured between two conductors, as opposed to a self-capacitance measurement in which the capacitance of a single conductor is measured, and which may be affected by other objects in proximity thereto.

Capacitive touchscreens and touch panels are employed in wide range of devices such as mobile telephones, and are typically employed to sense finger or stylus touches and movement. More sophisticated capabilities such as detecting objects other than fingers or styluses are rarely incorporated into capacitive touchscreen or touch panel systems, however.

What is needed is a capacitive measurement or sensing circuit or system that may be employed in touchscreen and touchpad applications that permits the functional detection capabilities of such circuits or systems to be expanded.

### SUMMARY

In one embodiment, there is a method of detecting at least one predetermined object held against a capacitive touchscreen by a user's finger or hand comprising driving with drive signals provided by drive circuitry a first plurality of electrically conductive drive electrodes arranged in rows or columns, sensing with sense circuitry a second plurality of electrically conductive sense electrodes arranged in rows or columns arranged at an angle with respect to the rows or columns of the first plurality of electrodes, mutual capacitances existing between the first and second pluralities of electrodes at locations where the first and second pluralities of electrodes intersect, the mutual capacitances changing in the presence of one or more fingers, touch devices or the predetermined object brought into proximity thereto, the sense circuitry providing as outputs therefrom sensed signals, routing the sensed signals to a processor, determining, with the processor, whether the sensed signals correspond to the at least one predetermined object on the basis of at least one predetermined range of mutual capacitances corresponding to the at least one predetermined object, the at least one predetermined range of mutual capacitances not corresponding to the user's finger or hand.

In another embodiment, there is provided a capacitive touchscreen or touch panel system comprising a touchscreen comprising a first plurality of electrically conductive drive electrodes arranged in rows or columns, and a second plurality of electrically conductive sense electrodes arranged in rows or columns arranged at an angle with respect to the rows or columns of the first plurality of electrodes, mutual capacitances existing between the first and second pluralities of electrodes at locations where the first and second pluralities of electrodes intersect to form individual cells, the mutual capacitances changing in the presence of one or more fingers or touch devices brought into proximity thereto, drive circuitry operably connected to the first plurality of drive electrodes, and sense circuitry operably connected to the second plurality of sense electrodes, wherein the system is configured to detect at least one predetermined object held against the touchscreen or touch panel by a user's finger or hand, the sense circuitry providing as outputs therefrom sensed signals, the system further being configured to rout the sensed signals to a processor, the processor being configured to determine whether the sensed signals correspond to the at least one predetermined object on the basis of at least one predetermined range of mutual capacitances corresponding to the at least one predetermined object, the at least one predetermined range of mutual capacitances not corresponding to the user's finger or hand.

Further embodiments are disclosed herein or will become apparent to those skilled in the art after having read and understood the specification and drawings hereof.

### BRIEF DESCRIPTION OF THE DRAWINGS

Different aspects of the various embodiments will become apparent from the following specification, drawings and claims in which:

FIG. 1 shows a cross-sectional view of one embodiment of a capacitive touchscreen system;

FIG. 2 shows a block diagram of a capacitive touchscreen controller;

FIG. 3 shows one embodiment of a block diagram of a capacitive touchscreen system and a host controller;

FIG. 4 shows a schematic block diagram of one embodiment of a capacitive touchscreen system;

FIG. 5 shows one embodiment of a predetermined object placed against a touchscreen;

FIG. 6 shows experimental images or frames obtained with a touchscreen controller for the configuration shown in FIG. 5;

FIG. 7 shows another embodiment of a predetermined object placed against a touchscreen;

FIG. 8 shows experimental images or frames obtained with a touchscreen controller for the configuration shown in FIG. 7;

FIG. 9 shows still another embodiment of a predetermined object placed against a touchscreen;

FIGS. 11 through 12 show experimental images or frames obtained with a touchscreen controller when a thumb was placed against a touchscreen in different orientations;

FIG. 14 shows one embodiment of an enrollment phase for an object detection system;

FIG. 15 shows one embodiment of an authentication phase for an object detection system, and

FIG. 16 shows one embodiment of a block diagram for circuitry configured to determine whether a Signal Frame matches a Reference Frame.

The drawings are not necessarily to scale. Like numbers refer to like parts or steps throughout the drawings.

### DETAILED DESCRIPTIONS OF SOME EMBODIMENTS

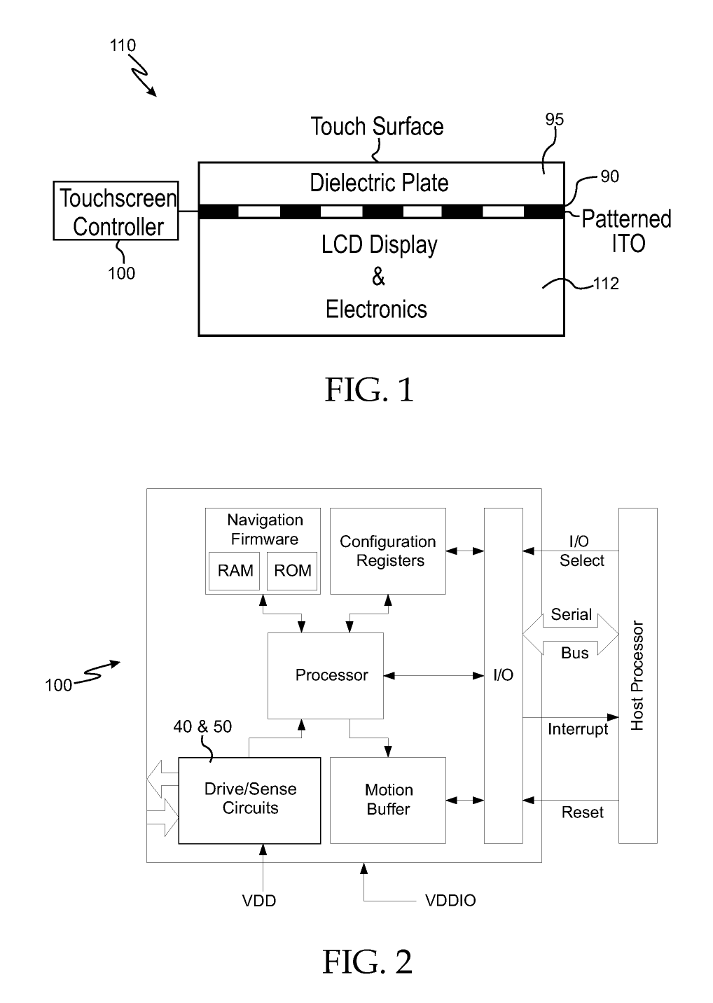

As illustrated in FIG. 1, a capacitive touchscreen system 110 typically consists of an underlying LCD or OLED display 112, an overlying touch-sensitive panel or touchscreen 90, a protective cover or dielectric plate 95 disposed over the touchscreen 90, and a touchscreen controller, micro-processor, application specific integrated circuit (“ASIC”) or CPU 100. Note that image displays other than LCDs or OLEDs may be disposed beneath touchscreen 90.

FIG. 2 shows a block diagram of one embodiment of a touchscreen controller 100. In one embodiment, touchscreen controller 100 may be an Avago Technologies™ AMRI-5000 ASIC or chip 100 modified in accordance with the teachings presented herein. In one embodiment, touchscreen controller is a low-power capacitive touch-panel controller designed to provide a touchscreen system with high-accuracy, on-screen navigation.

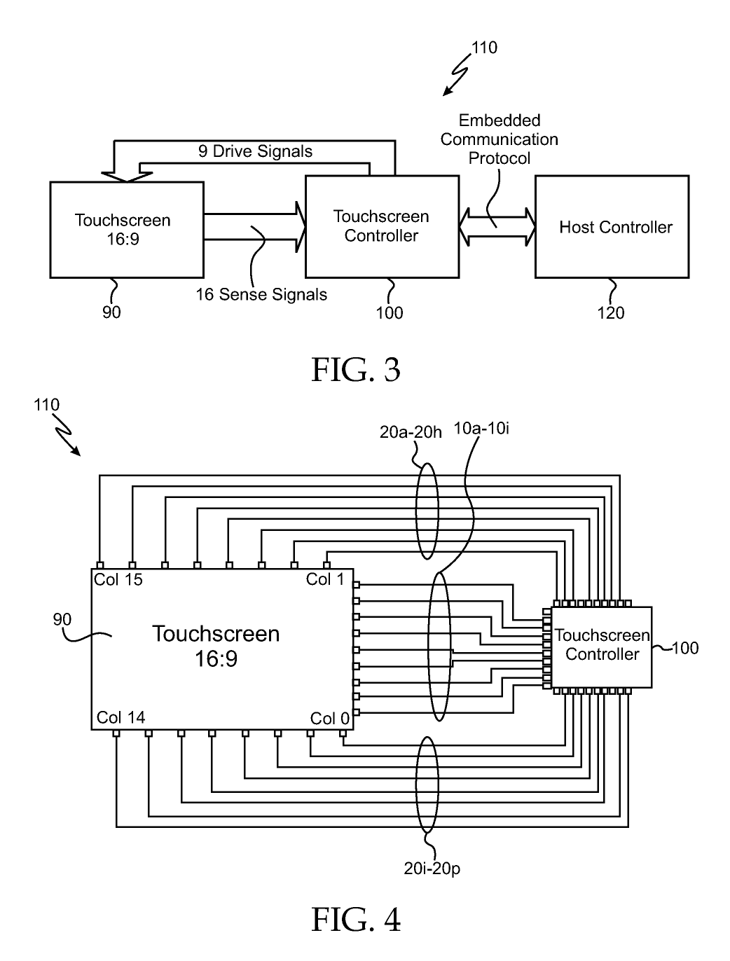

Capacitive touchscreens or touch panels 90 shown in FIGS. 3 and 4 can be formed by applying a conductive material such as Indium Tin Oxide (ITO) to the surface(s) of a dielectric plate, which typically comprises glass, plastic or another suitable electrically insulative and preferably optically transmissive material, and which is usually configured in the shape of an electrode grid. The capacitance of the grid holds an electrical charge, and touching the panel with a finger presents a circuit path to the user's body, which causes a change in the capacitance.

Touchscreen controller 100 senses and analyzes the coordinates of these changes in capacitance. When touchscreen 90 is affixed to a display with a graphical user interface, on-screen navigation is possible by tracking the touch coordinates. Often it is necessary to detect multiple touches. The size of the grid is driven by the desired resolution of the touches. Typically there is an additional cover plate 95 to protect the top ITO layer of touchscreen 90 to form a complete touch screen solution (see, e.g., FIG. 1).

One way to create a touchscreen 90 is to apply an ITO grid on one side only of a dielectric plate or substrate. When the touchscreen 90 is mated with a display there is no need for an additional protective cover. This has the benefit of creating a thinner display system with improved transmissivity (>90%), enabling brighter and lighter handheld devices. Applications for touchscreen controller 100 include, but are not limited to, smart phones, portable media players, mobile internet devices (MIDs), and GPS devices.

Referring now to FIGS. 3 and 4, in one embodiment the touchscreen controller 100 includes an analog front end with 9 drive signal lines and 16 sense lines connected to an ITO grid on a touchscreen. Touchscreen controller 100 applies an excitation such as a square wave, meander signal or other suitable type of drive signal to the drive electrodes that may have a frequency selected from a range between about 40 kHz and about 200 kHz. The AC signal is coupled to the sense lines via mutual capacitance. Touching touchscreen or touch panel 90 with a finger alters the capacitance at the location of the touch. Touchscreen controller 100 can resolve and track multiple touches simultaneously. A high refresh rate allows the host to track rapid touches and any additional movements without appreciable delay. The embedded processor filters the data, identifies the touch coordinates and reports them to the host. The embedded firmware can be updated via patch loading. Other numbers of drive and sense lines are of course contemplated, such as 8×12 and 12×20 arrays.

Touchscreen controller 100 features multiple operating modes with varying levels of power consumption. In rest mode controller 100 periodically looks for touches at a rate programmed by the rest rate registers. There are multiple rest modes, each with successively lower power consumption. In the absence of a touch for a certain interval controller 100 automatically shifts to the next-lowest power consumption mode. However, as power consumption is reduced the response time to touches increases.

According to one embodiment, and as shown in FIG. 4, an ITO grid or other electrode configuration on touchscreen 90 comprises sense columns 20a-20p and drive rows 10a-10i, where sense columns 20a-20p are operably connected to corresponding sense circuits and rows 10a-10i are operably connected to corresponding drive circuits. One configuration for routing ITO or other drive and sense electrodes to lines to touchscreen controller 100 is shown in FIG. 4.

Those skilled in the art will understand that touchscreen controllers, micro-processors, ASICs or CPUs other than a modified AMRI-5000 chip or touchscreen controller 100 may be employed in touchscreen system 110, and that different numbers of drive and sense lines, and different numbers and configurations of drive and sense electrodes, other than those explicitly shown herein may be employed without departing from the scope or spirit of the various embodiments of the invention.

Capacitive touch screens can be used for more than just tracking finger and stylus movements. Sensors such as the Avago AMRI-5000 can be thought of as capacitive image sensors. This interpretation becomes quite literal in the case of nearly planar, partially conductive objects placed on the surface of an associated touchscreen or touch panel, such as a 16×9 touchscreen 90 illustrated in FIG. 4. By processing the row and column intersection pixel values as a low resolution image, certain objects and their orientation can be detected.

It is known in the art for a touchscreen controller to interpret and report the row and column positions of finger or stylus contacts with a touchscreen, as well as the number of fingers touching the touchscreen. As described and disclosed herein, however, and according to one embodiment, predetermined object identification is also performed in addition to interpreting and reporting finger touches when a predetermined object is placed on or in close proximity to a touchscreen.

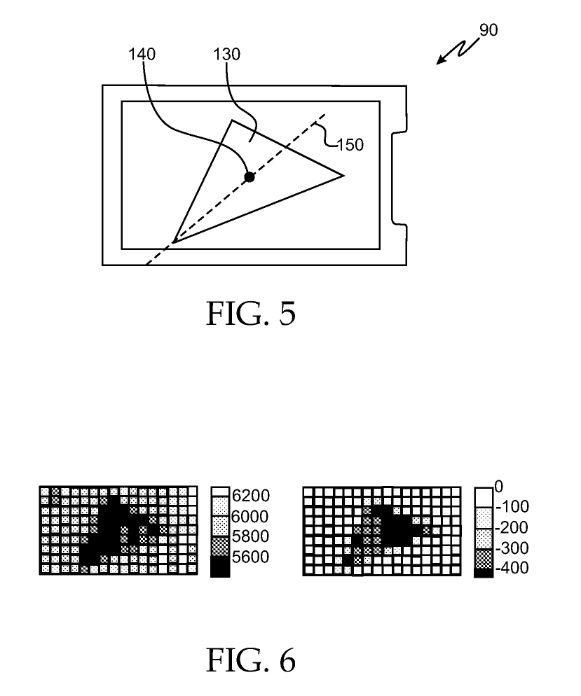

Example measurements to demonstrate feasibility of object recognition are now described. FIG. 5 shows one embodiment of a predetermined object 130 placed on touchscreen 90 centered at point 140 and having an orientation 150 with respect to the principal x and y axes of touchscreen 90. In FIG. 5, predetermined object 130 is a triangularly-shaped piece of electrically conductive plastic held in position on touchscreen 90 by a user's finger. Note that for purposes of clarity the user's finger is not shown in FIG. 5. FIG. 6 shows experimental results obtained using touchscreen 90 and the configuration of predetermined object 130 in FIG. 5 and an AVAGO TECHNOLOGIES AMRI-5100 touchscreen controller, where raw acquired signals are shown on the left, and change in raw signal relative to reference levels are shown on the right. FIG. 5 shows that touchscreen controller 100 and touchscreen or touch panel 90 may be configured to detect the shape and orientation of predetermined object 130.

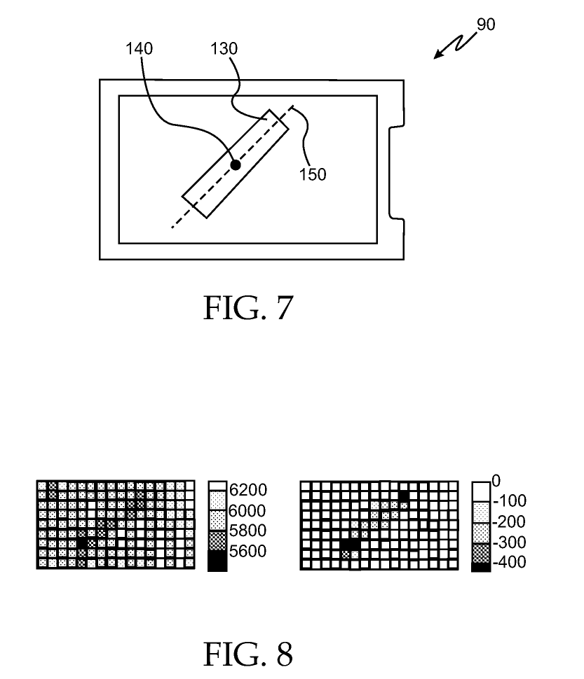

FIG. 7 shows another embodiment of a predetermined object 130 placed on touchscreen 90 centered at point 140 and having an orientation 150 with respect to the principal x and y axes of touchscreen 90. In FIG. 7, predetermined object 130 is a rectangularly-shaped piece of electrically conductive plastic held in position on touchscreen 90 by a user's finger. Note that for purposes of clarity the user's finger is not shown in FIG. 7. FIG. 8 shows experimental results obtained using touchscreen 90 and the configuration of predetermined object 130 in FIG. 7 and an AVAGO TECHNOLOGIES AMRI-5100 touchscreen controller, where raw acquired signals are shown on the left, and change in raw signal relative to reference levels are shown on the right. FIG. 8 shows that touchscreen controller 100 and touchscreen or touch panel 90 may be configured to detect the shape and orientation of predetermined object 130.

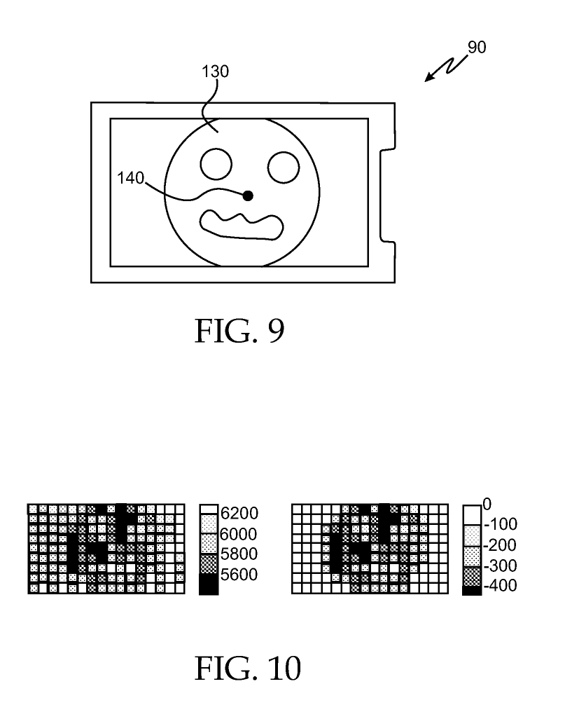

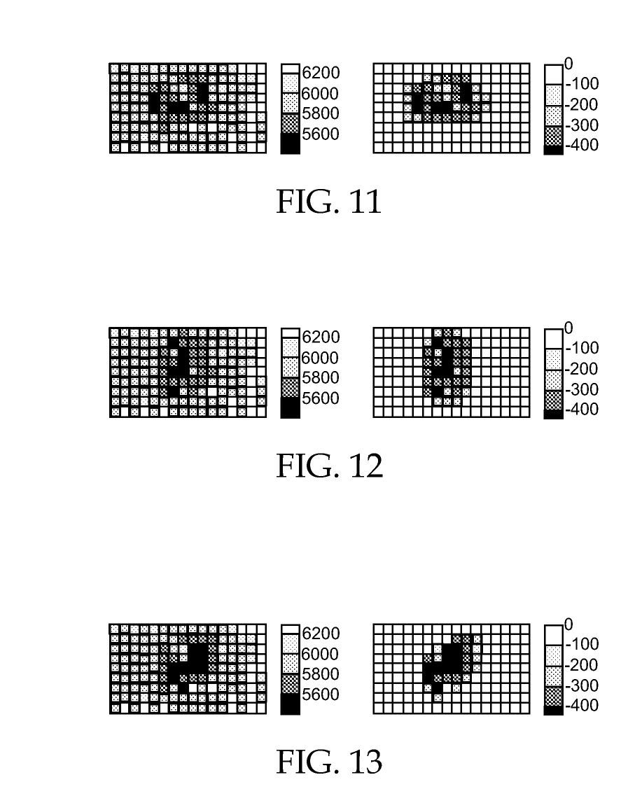

FIG. 9 shows yet another embodiment of a predetermined object 130 placed on touchscreen 90 centered at point 140. In FIG. 9, predetermined object 130 is a smiley-faced piece of electrically conductive plastic held in position on touchscreen 90 by a user's finger. Note that for purposes of clarity the user's finger is not shown in FIG. 97. FIG. 10 shows experimental results obtained using touchscreen 90 and the configuration of predetermined object 130 in FIG. 9 and an AVAGO TECHNOLOGIES AMRI-5100 touchscreen controller, where raw acquired signals are shown on the left, and change in raw signal relative to reference levels are shown on the right. FIG. 10 shows that touchscreen controller 100 and touchscreen or touch panel 90 may be configured to detect the shape and orientation of predetermined object 130.

FIGS. 11, 12 and 13 show experimental results obtained using touchscreen 90 of FIGS. 5, 7 and 9 with a thumb placed thereon in different positions. In FIG. 11, the thumb was placed with its longitudinal axis aligned with the x- or horizontal axis of touchscreen 90 (i.e., thumb tip pointing to the right). In FIG. 12, the thumb was placed with its longitudinal axis aligned with the y- or vertical axis of touchscreen 90 (i.e., thumb tip pointing to the top of touchscreen 90). In FIG. 13, the thumb was placed with its longitudinal axis aligned at roughly a 45-degree-angle with respect to the x- or y-axes of touchscreen 90. As in FIGS. 6, 8 and 10, raw acquired signals are shown on the left sides of FIGS. 11, 12 and 13, and processed delta signals (WHAT ARE DELTA SIGNALS?) are shown on the right sides of FIGS. 11, 12 and 13. FIGS. 11, 12 and 13 show that touchscreen controller 100 and touchscreen or touch panel 90 may be configured to detect the shape and orientation of a human thumb placed on touchscreen 90, and that thumb rotation can be extracted so that inputs to host controller 120 are not limited to x and y positions.

In the experiments illustrated in FIGS. 5 through 13, a capacitive touchscreen 90 and a capacitive touch controller 100 were configured as shown in FIG. 4. A square wave drive waveform of approximately 125 KHz was sequentially applied to each of several rows of capacitive touchscreen 90 through buffers. Touchscreen 90 comprised mutual capacitances of approximately 2 pF in magnitude between each row and column. Preamplifiers comprising adjustable capacitances and resistances in feedback elements of operational amplifiers were used on each column to detect signals arising from capacitance changes in each area of touchscreen 90. Signals were distinguished from noise by a differential demodulator to extract output components from the operational amplifiers which had the same frequency as the drive waveform. A low pass filter with a cutoff frequency near 80 KHz was used as an anti-aliasing filter before passing the sensed signals through a 9-bit differential Analog to Digital Converter (ADC).

After the ADC, further filtering was performed with a digital low pass filter having a cutoff frequency of approximately 2 KHz. Low pass filter outputs were placed in a frame random access memory (RAM) according to the corresponding location on touchscreen 90 of the corresponding or active row and column, and were designated as Raw Frames. At times when the touchscreen 90 was not being contacted, Raw Frame values were transferred to a Reference Frame RAM. Subsequent contact to the touchscreen 90 by fingers or other conductive objects in contact with such fingers were reflected as changes in the Signal Frame (which is the most recent Raw Frame) due to reductions in mutual capacitance relative to reference levels. These reductions in mutual capacitance arose from altering the fringing electromagnetic field patterns occurring between rows and columns of touchscreen 90. This, in turn, caused difference signals to appear at a subtractor output. An external or embedded microcontroller can then be used to analyze the values of the Signal Frame, interpret them, and provide results to the rest of the system (such as a mobile phone or portable computer).

According to another embodiment, predetermined object or shape token identification may further comprise an initial enrollment phase in which a predetermined object or electrically conductive token of a given shape and/or electrical conductivity or resistance is associated with an authorized users' name, identification or privilege level. One or more subsequent authentication phases may also be employed, where a pattern of a conductive shape token or predetermined object is compared with previously saved or stored information to determine which data corresponding to predefined users from among a set of such data match best. Such matches may be generated based on the size, shape, position, orientation and/or rotation of the electrically conductive shape token or predetermined object contact areas on touchscreen 90 sensed at relatively crude resolutions (for example 9 rows and 16 columns per FIG. 4) in the capacitive images presented in the Signal Frames.

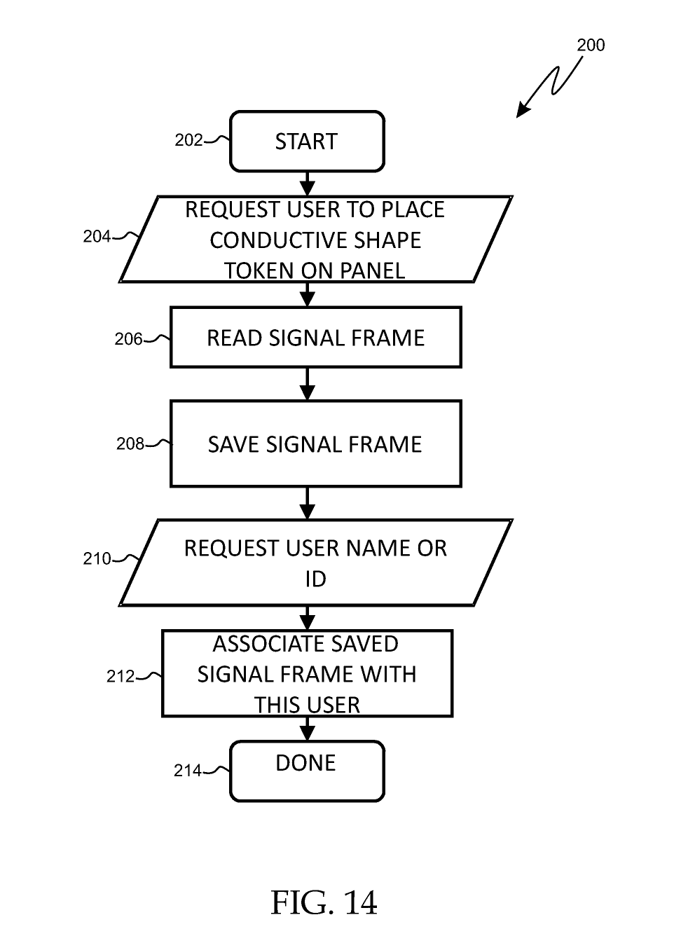

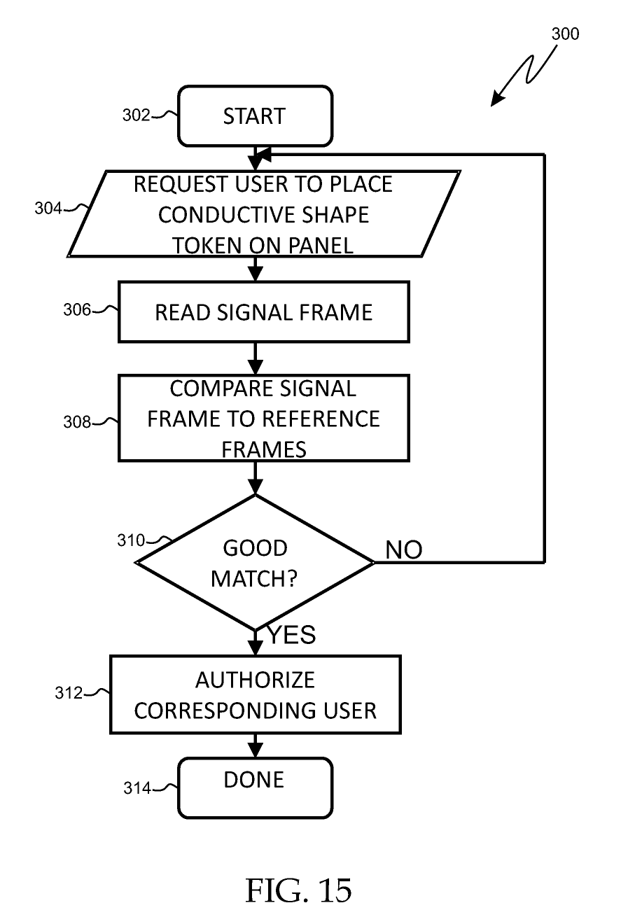

One embodiment of an enrollment phase 200 is shown in FIG. 14. At the start of initialization (steps 202 and 204), a display or other indicator requests that a user place an electrically conductive shape token or other predetermined object on touchscreen 90. After the token or object is in place on touchscreen 90, a controller or other processor examines the Signal Frame and obtains a capacitive image represented by the Signal Frame at step 206. The capacitive image is saved for future use in an authentication process (see FIG. 15). The user's name or other identification is then obtained at step 210 and associated with the Signal Frame image that has been saved to memory. This completes the normal enrollment phase. Abnormal enrollment can also be detected at any stage in process 200 to detect adverse conditions, such as the user not actually placing a shape token or predetermined object on touchscreen 90, the user placing a flat palm against touchscreen 90, or other abnormal situations.

One embodiment of an authentication phase 300 is shown in FIG. 15. As in enrollment phase 200, a display or other indicator requests that a user place an electrically conductive shape token or predetermined object on touchscreen 90 at step 304. After the token or object has been placed on or held in contact with touchscreen 90, a controller or other processor obtains a Signal Frame at step 306. At step 308, the Signal Frame is compared to previously saved or stored data to find a best match. Depending on the quality of the match (step 310), the user's shape token or predetermined object is either accepted as being a previously enrolled token or predetermined object, or is rejected as a new or unknown token or predetermined object In the absence of a good match, and according to one embodiment, process 300 can be restarted.

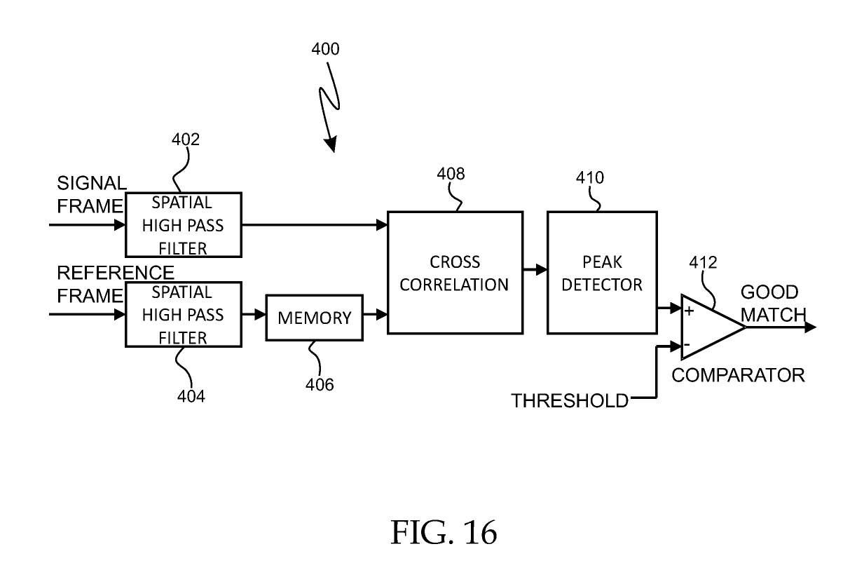

FIG. 16 shows one embodiment of a block diagram of circuitry configured to determine whether a match can be determined between previously saved images on the one hand (Reference Frames), and current Signal frames on the other hand. In one embodiment, the Signal Frames and the Reference Frames (or images) are spatially filtered to remove DC content (since DC content in such images or frames does not contain relevant information regarding image shape) and to emphasize the spatial frequency ranges most relevant to limitations of the relatively crude capacitive imaging capabilities of some touchscreens 90 (see Spatial High Pass Filters 402 and 404 in FIG. 16). The Reference Frame's spatially filtered result is stored in a memory array 406 for future use. The current Signal Frame's spatially filtered result and the previously saved spatially filtered Reference Frame images are then provided to a two-dimensional cross-correlation circuit 408, which can be implemented in digital hardware or in firmware running on a microcontroller, by way of example. In one embodiment, the output of cross-correlation circuit 408 is an array of numbers indicating the degree of match between the two input images for a variety of postulated shift positions along the x and y axes. This cross-correlation output array is provided to a peak detector 410, which selects the highest value indicating the quality of the best match between the Signal Frame and Reference Frame within the considered range of x and y axes shift values. If the output of peak detector 410 exceeds a predetermined threshold, the two images are considered to be a sufficiently good match for purposes of authentication.

In further embodiments, a first range of end-to-end electrical resistances may be associated with a predetermined object or shape taken 103, such as between about 0 ohms and about 10 ohms, or between about 1,000 ohms and about 1 megaohm. Such ranges of end-to-end electrical resistances lie outside the ranges of electrical resistances typically associated with a user's finger or other body portion, and therefore affect the mutual capacitances generated on touchscreen 90 in a manner entirely different from those generated by a human finger or hand touch. System 110 may be configured to determine sensed signals generated by touchscreen 90 correspond to at least one predetermined object 103, and may further be configured to determine whether the predetermined object has a predetermined shape, is being held against touchscreen 90 at a predetermined location thereon, and/or is being held against touchscreen 90 within a prescribed range of orientations with respect to touchscreen 90. Controller 100 or host controller 120 may also be configured to carry out an additional step after determining that the sensed signals correspond to the predetermined object, such as unlocking a device to which touchscreen 90 and system 110 are operably connected, permitting a user to access information or data provided by a device to which touchscreen 90 and system 110 are operably connected, and permitting a user to operate or control a device to which touchscreen 90 and system 110 are operably connected.

In other embodiments, and prior to the enrollment phase, the predetermined object may be selected by the user and may be a household or automobile key, for example. In still other embodiments, the processor may be a host controller 120 operably connected to touchscreen controller 100 that is configured to receive the sensed signals.

Note that in still further embodiments, tracking of the movement of predetermined object 130 on touchscreen 90 may be implemented using filtering and cross-correlation signal processing methods such as those described above, or those which have been developed for use in optical mice such as described in U.S. Pat. No. 6,433,780 to Gordon et al. entitled “Seeing Eye Mouse for a Computer System,” which patent is hereby incorporated by reference herein in its entirety. Object recognition techniques may also be implemented using template matching techniques developed by the military and from the field of optical character recognition (“OCR”).

Various embodiments of the invention are contemplated in addition to those described in detail above. For example, object recognition may be useful in various ways such as unlocking a mobile phone by placing a personal shape key or token against touchscreen 90, playing a game involving one or more tokens placed on touchscreen 90 by recognizing a token of a predetermined shape or having certain predetermined physical characteristics such as predefined ranges of end-to-end electrical resistances, determining the rotational orientation of a finger or thumb contact area for use as an additional input to control volume, photo rotation or other functions of a device, rotating TETRIS-like objects in games, identifying coin sizes for amusement or education, and many other applications. Floating electrically conductive objects can also be distinguished from electrically conductive objects held or contacted by a finger based on the increased mutual capacitances exhibited by certain edge cells on a touchscreen 90. Through such mechanisms, finger contact and release from electrically conductive objects placed on a touchscreen 90 may be detected. One example of such a use would be to detect when a chess player position should be frozen based on the release of the player's finger from a chess piece.

Included within the scope of the present invention are methods of making and having made the various components, devices and systems described herein. The above-described embodiments should be considered as examples of the present invention, rather than as limiting the scope of the invention. In addition to the foregoing embodiments of the invention, review of the detailed description and accompanying drawings will show that there are other embodiments of the present invention. Accordingly, many combinations, permutations, variations and modifications of the foregoing embodiments of the present invention not set forth explicitly herein will nevertheless fall within the scope of the present invention.

I claim:

1. A method of detecting at least one predetermined object held against a capacitive touchscreen by a user's finger or hand, comprising:
driving with drive signals provided by drive circuitry a first plurality of electrically conductive drive electrodes arranged in rows or columns;
sensing with sense circuitry a second plurality of electrically conductive sense electrodes arranged in rows or columns arranged at an angle with respect to the rows or columns of the first plurality of electrodes, mutual capacitances existing between the first and second pluralities of electrodes at locations where the first and second pluralities of electrodes intersect, the mutual capacitances changing in the presence of one or more fingers, touch devices or the predetermined object brought into proximity thereto, the sense circuitry providing as outputs therefrom sensed signals;
routing the sensed signals to a processor;
determining, with the processor, whether the sensed signals correspond to the at least one predetermined object on the basis of at least one predetermined range of mutual capacitances corresponding to the at least one predetermined object, the at least one predetermined range of mutual capacitances not corresponding to the user's finger or hand.

2. The method of claim 1, wherein a first range of end-to-end electrical resistances is associated with the first predetermined object.

3. The method of claim 2, wherein the first range of end-to-end electrical resistances is between about 0 ohms and about 10 ohms.

4. The method of claim 2, wherein the first range of end-to-end electrical resistances is between about 1,000 ohms and about 1 megaohm.

5. The method of claim 1, wherein determining whether the sensed signals correspond to the at least one predetermined object further comprises determining whether the at least one predetermined object has a predetermined shape.

6. The method of claim 1, wherein determining whether the sensed signals correspond to the at least one predetermined object further comprises determining whether the at least one predetermined object is being held against the touchscreen at a predetermined location on the touchscreen.

7. The method of claim 1, wherein determining whether the sensed signals correspond to the at least one predetermined object further comprises determining whether the at least one predetermined object is being held against the touchscreen within a prescribed range of orientations with respect to the touchscreen.

8. The method of claim 1, further comprising carrying out an additional step in response to determining that the sensed signals correspond to the at least one predetermined object.

9. The method of claim 8, wherein the additional step comprises unlocking a device to which the touchscreen is operably connected.

10. The method of claim 8, wherein the additional step comprises permitting a user to access information or data provided by a device to which the touchscreen is operably connected.

11. The method of claim 8, wherein the additional step comprises permitting a user to operate or control a device to which the touchscreen is operably connected.

12. The method of claim 1, wherein the predetermined object is selected by the user.

13. The method of claim 12, wherein the predetermined object is held against the touchscreen during an enrollment phase.

14. The method of claim 12, wherein the predetermined object is held against the touchscreen during an authentication phase.

15. The method of claim 1, wherein the processor is a touchscreen controller.

16. The method of claim 1, wherein the processor is a host controller operably connected to a touchscreen controller and configured to receive the sensed signals.

17. A capacitive touchscreen or touch panel system, comprising:
a touchscreen comprising a first plurality of electrically conductive drive electrodes arranged in rows or columns, and a second plurality of electrically conductive sense electrodes arranged in rows or columns arranged at an angle with respect to the rows or columns of the first plurality of electrodes, mutual capacitances existing between the first and second pluralities of electrodes at locations where the first and second pluralities of electrodes intersect to form individual cells, the mutual capacitances changing in the presence of one or more fingers or touch devices brought into proximity thereto;
drive circuitry operably connected to the first plurality of drive electrodes, and
sense circuitry operably connected to the second plurality of sense electrodes;
wherein the system is configured to detect at least one predetermined object held against the touchscreen or touch panel by a user's finger or hand, the sense circuitry providing as outputs therefrom sensed signals, the system further being configured to rout the sensed signals to a processor, the processor being configured to determine whether the sensed signals correspond to the at least one predetermined object on the basis of at least one predetermined range of mutual capacitances corresponding to the at least one predetermined object, the at least one predetermined range of mutual capacitances not corresponding to the user's finger or hand.

18. The system of claim 17, wherein a first range of end-to-end electrical resistances is associated with the first predetermined object.

19. The system of claim 17, wherein the first range of end-to-end electrical resistances is between about 0 ohms and about 10 ohms.

20. The system of claim 17, wherein the first range of end-to-end electrical resistances is between about 1,000 ohms and about 1 megaohm.

21. The system of claim 17, wherein the processor is further configured to determine whether the sensed signals corresponding to the at least one predetermined object correspond to a predetermined shape.

22. The system of claim 17, wherein the processor is further configured to determine whether the sensed signals corresponding to the at least one predetermined object correspond to the at least one predetermined object being held against the touchscreen at a predetermined location on the touchscreen.

23. The system of claim 17, wherein the processor is further configured to determine whether the sensed signals corresponding to the at least one predetermined object correspond to the at least one predetermined object being held against the touchscreen within a prescribed range of orientations with respect to the touchscreen.

23. The system of claim 17, wherein the processor is further configured to carry out at least one additional step in response to determining that the sensed signals correspond to the at least one predetermined object.

24. The system of claim 23, wherein the additional step comprises unlocking a device to which the touchscreen is operably connected.

25. The system of claim 23, wherein the additional step comprises permitting a user to access information or data provided by a device to which the touchscreen is operably connected.

26. The system of claim 23, wherein the additional step comprises permitting a user to operate or control a device to which the touchscreen is operably connected.

27. The system of claim 17, wherein the predetermined object is selected by the user.

28. The system of claim 17, wherein the system is further configured to execute an enrollment phase when the predetermined object is held against the touchscreen.

29. The system of claim 17, wherein the system is further configured to execute an authentication phase when the predetermined object is held against the touchscreen.

30. The system of claim 17, wherein the processor is a touchscreen controller.

31. The system of claim 17, wherein the processor is a host controller operably connected to a touchscreen controller and configured to receive the sensed signals.
